(19) United States
(12) Patent Application Publication
(10) Pub. No.: US 2004/0182672 A1
(43) Pub. Date: Sep. 23, 2004

(54) Friction body

(75) Inventors: Gerhard Hartner, Neydharting (AT); Volker Foge, Ebensee (AT)

Correspondence Address: Kurt Kelman, COLLARD & ROE, P.C., 1077 Northern Boulevard, Roslyn, NY, 11576, US

(73) Assignee: MIBA FRICTEC GMBH

(21) Appl. No.: 10/762,109

(22) Filed: Jan. 21, 2004

(30) Foreign Application Priority Data
Jan. 22, 2003 (AT) A 79/2003

(51) Int. Cl. B60L 7/00

(52) U.S. Cl. 192/107 M

(57) ABSTRACT

The invention relates to a friction body with a steel girder (1) and with a friction lining (2) made of carbon fibers which is glued onto the steel girder (1). In order to provide simple constructional conditions it is proposed that a porous intermediate layer (3) is provided between the friction lining (2) and the steel girder (1), which porous intermediate layer is joined via one adhesive layer (4, 5) each with the friction lining (2) on the one hand and with the steel girder (1) on the other hand.

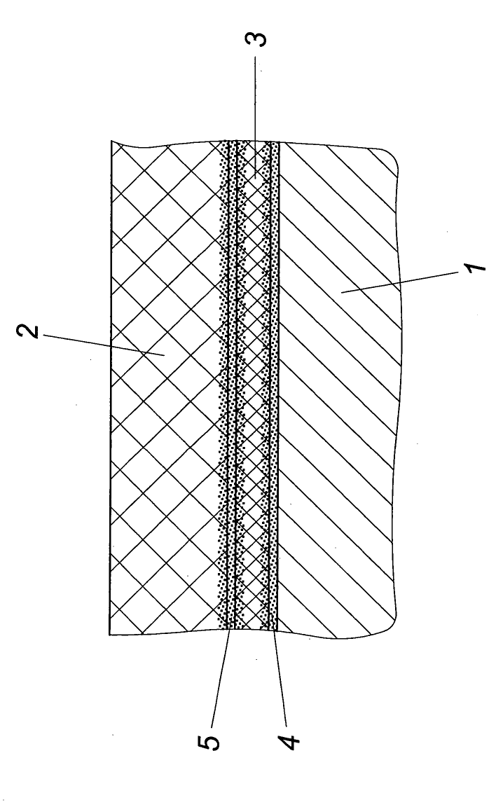

### FIELD OF THE INVENTION

The invention relates to a friction body with a steel girder and with a friction lining made of carbon fibers which is glued onto the steel girder.

### DESCRIPTION OF THE PRIOR ART

Friction linings made of carbon fibers are usually glued onto the steel girders. Since carbon fibers have a comparatively high thermal conductivity, one must expect a respective temperature load of the adhesive layer between the friction lining and the steel girder in the case of high temperature loads of such friction linings. With rising temperature, however, the adhesive powers between the adhesive layer and the steel girder will decrease, leading to an impairment of the bonding of the friction lining on the steel girder. Another aspect is that the thermal expansion of the carbon fibers is far lower than that of the steel girder, so that higher tensions of the adhesive layer are unavoidable at higher temperature loads of the friction lining. These facts can therefore lead to a bonding failure of the adhesive layer between the friction lining made of carbon fibers and the steel girder.

### SUMMARY OF THE INVENTION

The invention is thus based on the object of providing a friction body of the kind mentioned above in such a way that even at high temperature loads of the friction lining one can expect a secure bonding of the friction lining on the steel girder.

This object is achieved by the invention in such a way that a porous intermediate layer is provided between the friction lining and the steel girder, which porous intermediate layer is joined via one adhesive layer each with the friction lining on the one hand and with the steel girder on the other hand.

The intermediate layer provided between the friction lining and the steel girder forms a thermal insulation when a respective choice of material is made, which thermal insulation protects the adhesive layer between the intermediate layer and the steel girder from thermal overloading, so that the adhesive forces of the temperature-sensitive adhesive bonding is maintained to a sufficient extent. The adhesive layer between the friction lining and the intermediate layer is subjected to the full temperature load. This is of subordinate importance with respect to the adhesive forces between the friction lining and the intermediate layer, because a positive-locking connection is obtained by the porosity of the intermediate layer by way of the adhesive material penetrating the pores, which connection can easily ensure the required adhesive forces. An additional aspect is that the porous intermediate layer can produce an expansion compensation between the friction lining and the steel girder, so that the adhesive layers per se can be kept substantially free from tensions as a result of the different thermal expansion behavior of the friction lining and the steel girder.

In order to provide adequate heat protection for the adhesive layer between the intermediate layer and the steel girder, it is recommended to provide the intermediate layer of a heat-insulating material. The intermediate layer per se must be sufficiently porous and provide in combination with favorable own strength a suitable elastic behavior for compensating the different thermal expansions between the friction lining and the steel girder, so that the adhesive layers between the intermediate carrier on the one hand and the friction lining or steel girder on the other hand are subject to only very low tensions. These requirements can be fulfilled advantageously by an intermediate layer which consists of a paper on the basis of sulfate cellulose. Another advantageous possibility for forming an intermediate layer is obtained when a fiber composite is used between the friction lining and the steel girder which obviously needs to be sufficiently temperature-resistant.

### BRIEF DESCRIPTION OF THE DRAWINGS

The drawing shows the subject matter of the invention by way of example, namely a friction body in accordance with the invention in a schematic sectional view.

### DESCRIPTION OF THE PREFERRED EMBODIMENT

The friction body substantially consists of a steel girder 1 onto which a friction lining 2 made of carbon fibers is glued. Said friction lining 2 can be made of a fabric which is partly impregnated with artificial resin and is made of twisted carbon fibers or a partly impregnated non-woven material made of carbon fibers. In contrast to conventional adhesive connections, the friction lining 2 is not glued directly onto the steel girder 1, but via a porous intermediate layer 3. This means that the intermediate layer 3 needs to be joined via an adhesive layer 4 with the steel girder 1 and the friction lining 2 via an adhesive layer 5 with the intermediate layer 3. The intermediate layer 3 which can preferably consist of a paper made of sulfate cellulose or a temperature-resistant fiber composite generally has a thickness of 0.2 to 1 mm. Since the adhesive material of the adhesive layers 4 and 5 will penetrate the pores of the porous intermediate layer 3 (as is shown in the drawing), a positive-locking connection is obtained between the adhesive layers 4 and 5 on the one hand and the intermediate layer 3 on the other hand, which positive-locking connection is hardly dependent on the temperature load of the friction lining 2, in contrast to an adhesive bonding. For this reason it is possible to ensure a favorable connection between the friction lining 2 and the intermediate layer 3, despite a high temperature load, since the bonding of the adhesive layer 6 relative to the friction lining 2 which is impregnated with artificial resin is not problematic.

The adhesive layer 4 between the intermediate layer 3 and the steel girder 1 represents an adhesive bonding towards the steel girder 1, which bonding needs to be protected against higher temperature influences in order to ensure the required adhesive forces. This is achieved by the thermal-insulating properties of the intermediate layer 3, which also ensures tension compensation as a result of its elastic properties. The friction lining 2 made of carbon fibers has a far lower thermal expansion relative to steel, so that tensions thus caused in the adhesive layers 4 and 5 can only be prevented when these differences in expansion are absorbed by the intermediate layer 3. The intermediate layer 3 which needs to have a sufficiently high inherent strength in order to avoid limiting the adhesive forces by the inherent strength of the intermediate layer 3 thus allows also achieving an adhesion of the friction lining 2 with the steel girder 1 which also meets high requirements concerning the temperature load.

For producing a friction body in accordance with the invention, the friction lining 2 made of carbon fibers can be laminated with adhesive material. It is possible to use both liquid adhesive as well as films with adhesive material. The adhesive preferably consists of a mixture of phenol resin with natural caoutchouc. Thereafter the intermediate layer 3 and the friction lining 2 are joined under a low pressure at a temperature of between 70 and 120° C. before either the lower side of the intermediate layer 3 or the steel girder 1 is laminated with adhesive. The application of the friction lining 2 which is joined to the intermediate layer 3 onto the steel girder 1 occurs in a heating press. A desired porosity with a pore volume of between 20 and 70 percent by volume in the intermediate layer 3 is achieved on the basis of the predetermined pressure, the setting time (30 to 150 seconds) and the temperature (170 to 260° C.). As a result of the heating and the pressure application the adhesive liquefies and penetrates the intermediate layer 3 or the friction lining 2 due to the capillary or diffusion effects until the adhesive polymerizes through the continuing heat effect. The thickness both of the, intermediate layer 3 as well as the friction lining 2 is generally between 0.2 and 1 mm.

1. A friction body with a steel girder and with a friction lining made of carbon fibers which is glued onto the steel girder, characterized in that a porous intermediate layer (3) is provided between the friction lining (2) and the steel girder (1), which porous intermediate layer is joined via one adhesive layer (4, 5) each with the friction lining (2) on the one hand and with the steel girder (1) on the other hand.

2. A friction body as claimed in claim 1, characterized in that the intermediate layer (3) consists of a heat-insulating material.

3. A friction body as claimed in claim 1 or 2, characterized in that the porous intermediate layer (3) consists of a paper on the basis of sulfate cellulose.

4. A friction body as claimed in claim 1 or 2, characterized in that the porous intermediate layer (3) consists of a fiber composite.
